SEQUENCE LISTING (12 sequences)

SEQ ID NO: 1 - DNA, 21 bp, Artificial Sequence
  Description of Artificial Sequence Synthetic primer
acaagctccacctggactaca

SEQ ID NO: 2 - DNA, 19 bp, Artificial Sequence
  Description of Artificial Sequence Synthetic primer
tcttcttcacacgcagttt

SEQ ID NO: 3 - DNA, 20 bp, Artificial Sequence
  Description of Artificial Sequence Synthetic primer
gacggccgaggtgatagctt

SEQ ID NO: 4 - DNA, 21 bp, Artificial Sequence
  Description of Artificial Sequence Synthetic primer
catggctggtcttcccgttgc

SEQ ID NO: 5 - DNA, 16 bp, Artificial Sequence
  Description of Artificial Sequence Synthetic primer
aaagcccagcgactct

SEQ ID NO: 6 - DNA, 21 bp, Artificial Sequence
  Description of Artificial Sequence Synthetic primer
ctaaacggtggtgccatagat

SEQ ID NO: 7 - DNA, 19 bp, Artificial Sequence
  Description of Artificial Sequence Synthetic primer
tcctgccgatgtcgctatc

SEQ ID NO: 8 - DNA, 21 bp, Artificial Sequence
  Description of Artificial Sequence Synthetic primer
caagttccggtgtgactcgtg

SEQ ID NO: 9 - DNA, 20 bp, Artificial Sequence
  Description of Artificial Sequence Synthetic primer
gcttctccaacccacgaatg

SEQ ID NO: 10 - DNA, 21 bp, Artificial Sequence
  Description of Artificial Sequence Synthetic primer
gaactgataggacgctgacga

SEQ ID NO: 11 - DNA, 20 bp, Artificial Sequence
  Description of Artificial Sequence Synthetic primer
cgacctggaagtccaactac

SEQ ID NO: 12 - DNA, 18 bp, Artificial Sequence
  Description of Artificial Sequence Synthetic primer
atctgctgcatctgcttg

(19) United States
(12) Patent Application Publication
(10) Pub. No.: US 2010/0327494 A1
(43) Pub. Date: Dec. 30, 2010

(54) Electrospun Fibrous Three-Dimensional Scaffolds with Well-Defined Pore Geometry

(75) Inventor: Esmaiel Jabbari, Columbia, SC (US)

Correspondence Address: DORITY & MANNING, P.A., POST OFFICE BOX 1449, GREENVILLE, SC, 29602-1449, US

(73) Assignee: UNIVERSITY OF SOUTH CAROLINA, Columbia, SC (US)

(21) Appl. No.: 12/820,691

(22) Filed: Jun. 22, 2010

Related U.S. Application Data
(60) Provisional application No. 61/269,214, filed on Jun. 22, 2009.

(51) Int. Cl. B29C 47/36

(52) U.S. Cl. 264/466

(57) ABSTRACT

In accordance with certain embodiments of the present disclosure, a method for fabricating multi-layer fibrous scaffolds with a well-defined pore geometry is provided. The method includes electrospinning generally parallel rows of biodegradable synthetic polymer fibers onto a collector plate, wherein the fibers of each generally parallel row on the collector plate are generally aligned as they are electrospun onto the collector plate. The collector plate is rotated and additional generally parallel rows of biodegradable synthetic polymer fibers are electrospun onto the collector plate, wherein the additional fibers on the collector plate are generally aligned as they are electrospun onto the collector plate and a multi-layer scaffold is formed. The process can be continued to form a multi-layer fibrous scaffold with macropores of well-defined geometry.

### CROSS-REFERENCE TO RELATED APPLICATION

The present application is based on and claims priority to U.S. Provisional Application 61/269,214 having a filing date of Jun. 22, 2009, which is incorporated by reference herein.

### BACKGROUND

Electrospinning is a powerful and versatile process for producing polymeric fibers with micro and nanosize diameter. Naturally derived as well as synthetic polymers like collagen, gelatin, chitosan, poly (lactic acid) (PLA), poly(glycolic acid) (PGA), and poly(lactide-co-glycolide) (PLGA) have been used for electrospinning. In addition to the chemical structure of the polymer, many parameters such as solution properties (e.g., viscosity, conductivity, surface tension, polymer molecular weight, dipole moment, and dielectric constant), process variables (e.g., flow rate, electric field strength, distance between the needle and collector, needle tip design, and collector geometry), and ambient conditions (e.g., temperature, humidity, and air velocity) can be manipulated to produce fibers with desired composition, shape, size, and thickness. Polymer solution viscosity and collector geometry are the most important factors determining the size and morphology of electrospun fibers. Below a critical solution viscosity, the accelerating jet from the tip of the capillary breaks into droplets as a result of surface tension. Above a critical viscosity, the repulsive force resulting from the induced charge distribution on the droplet overcomes the surface tension, the accelerating jet does not break up, and results in collection of fibers on the grounded target. Aligned fibers can be produced using a rotating disk as the collector.

High porosity and surface-area-to-volume ratio, similar morphology to the natural extra-cellular matrix, degradability, biocompatibility and mechanical strength make electrospun polymer fibers the perfect candidate for engineering of soft tissues like skin, blood vessels, heart valve, and articular cartilage. Scaffolds produced by these mesh of fibers can potentially create a viable environment for cell proliferation, migration, and differentiation. Electrospun fibers produced by biodegradable synthetic polymers like PLA, PGA and their copolymers PLGA are potentially useful for clinical applications because their degradation products, lactic acid and glycolic acid, are resorbed through the metabolic pathways. Furthermore, the flexibility in their design allows the synthesis of a wide range of polymers with varying mechanical, biologic and degradation properties to suit various applications. However, with existing electrospinning apparatus/designs, it is not possible to fabricate three-dimensional porous objects/scaffolds with well-defined pore geometry. Furthermore, although the effect of fiber diameter and orientation on cell morphology, adhesion, and proliferation has been studied, there have been few studies quantitatively comparing osteogenic differentiation and gene expression of marrow stem cells on random fibers with those on aligned fibers under identical culture conditions.

In view of the above, a need exists for a method to fabricate porous fibrous scaffolds with well-defined pore geometry. In addition, a need also exists for a quantitative determination of the differences in osteogenic differentiation and gene expression of marrow stem cells on random fibers with those on aligned fibers.

### SUMMARY

In accordance with certain embodiments of the present disclosure, a method for fabricating multi-layer scaffolds with a well-defined pore geometry is provided. The method includes electrospinning generally parallel rows of biodegradable synthetic polymer fibers onto a collector plate, wherein the fibers in each of the rows on the collector plate are generally aligned as they are electrospun onto the collector plate. The collector plate is rotated and additional generally parallel rows of biodegradable synthetic polymer fibers are electrospun onto the collector plate, wherein the additional fibers in each of the rows on the collector plate are generally aligned as they are electrospun onto the collector plate and a multi-layer scaffold is formed. The process can be repeated any number of times to form a multi-layer fibrous scaffold with macropores of well-defined geometry. In this regard, the spacing between generally parallel rows can dictate porosity of the scaffold.

In still other embodiments of the present disclosure, a method for fabricating multi-layer scaffolds with a well-defined pore geometry is provided. The method includes electrospinning biodegradable synthetic polymer fibers onto a collector plate, wherein the fibers on the collector plate are generally aligned as they are electrospun onto the collector plate. The collector plate is moved forward or backward and additional biodegradable synthetic polymer fibers are electrospun onto the collector plate, wherein the additional fibers are generally parallel with the fibers on the collector plate and are generally aligned as they are electrospun onto the collector plate. The collector plate is rotated and still additional biodegradable synthetic polymer fibers are electrospun onto the collector plate, wherein the still additional fibers on the collector plate are generally aligned as they are electrospun onto the collector plate and a multi-layer scaffold is formed.

Other features and aspects of the present disclosure are discussed in greater detail below.

### BRIEF DESCRIPTION OF THE DRAWINGS

A full and enabling disclosure, including the best mode thereof, directed to one of ordinary skill in the art, is set forth more particularly in the remainder of the specification, which makes reference to the appended figures in which:

FIG. 1 illustrates a) a schematic diagram of a two wheel electrospinning apparatus before rotation of the collecting plate in accordance with certain aspects of the present disclosure, b) a schematic diagram of a two wheel electrospinning apparatus after rotation of the collecting plate in accordance with certain aspects of the present disclosure, c) a schematic diagram of an electrospinning apparatus to produce random and d) aligned nanofibers. The arrows on the plate in (c) and the rotating wheel in (d) show the reference direction for determination of statistical deviation from ideal random and aligned fibers, respectively.

FIG. 2 illustrates SEM micrographs of the electrospun fibers collected on the rotating wheel at the speed of 500 (a) and 1200 (b) rpm from 9.0 wt % PLLA in HFIP solvent. The diameter of the wheel was 20 cm.

FIG. 3 illustrates SEM micrographs of (a) random and (b) aligned fibers, electrospun from 9.0 wt % PLLA in HFIP solvent. The diameter and rotation speed of the collecting wheel were 20 cm and 1200 rpm, respectively.

FIG. 4 illustrates SEM micrographs of the fibers seeded with BMS cells after incubation in osteogenic media for 4 days (a for random and b for aligned) and 21 days (c for random and d for aligned). Images (e) and (f) are alizarin red stained light microscope images of BMS cell-seeded random and aligned fibers after 21 days incubation in osteogenic media.

FIG. 5 illustrates SEM micrographs showing higher magnification (3000×) of the BMS cells seeded on the random (a) and aligned (b) fibers after incubation in osteogenic media for 4 days.

FIG. 6 illustrates normalized histograms comparing the distribution of the fibers with that of the seeded cells for fibers collected on the solid plate (a) and fibers collected on the rotating wheel with 1200 rpm rotation speed (b). The reference direction on the plate is shown by the arrow in FIG. 1a. The reference direction along the tangent to the perimeter of the rotating wheel is shown by the arrow in FIG. 1b.

FIG. 7 illustrates DNA content (A), ALPase activity (B), and calcium content (C) of the BMS cells seeded on PLLA fibers cultured in osteogenic media. Experimental groups include random (blue) and aligned (orange) fibers. Time points include 4, 7, 14, and 21 days. One star indicates statistically significant difference (α=0.05) between the test time point and day 4 in the same group. Two stars indicate statistically significant difference (α=0.05) between the test time and all other time points in the same group. Three stars indicate statistically significant difference (α=0.05) between the test group and the other group for the same time point. Error bars correspond to means±1 SD for n=3.

FIG. 8 illustrates mRNA expression levels (as fold difference) of osteopontin (A, OP), osteocalcin (B, OC), an osteonectin (C, ON) of the BMS cells seeded on PLLA fibers cultured in osteogenic media. Experimental groups include random (blue) and aligned (orange) fibers. Time points include 4, 7, 14, and 21 days. One star indicates statistically significant difference (α=0.05) between the test time point and day 4 in the same group. Two stars indicate statistically significant difference (α=0.05) between the test time and all other time points in the same group. Error bars correspond to means±1 SD for n=3.

### DETAILED DESCRIPTION

Reference now will be made in detail to various embodiments of the disclosure, one or more examples of which are set forth below. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment, can be used on another embodiment to yield a still further embodiment. Thus, it is intended that the present disclosure covers such modifications and variations as come within the scope of the appended claims and their equivalents.

The present disclosure is directed to the use of an electrospinning apparatus as a line printer to print scaffolds. Applications of the present disclosure include fabrication of porous scaffolds with well-defined pore geometry. The fibrillar structure and sub-micron diameter of electrospun nanofibers can also be used to reproduce the morphology and structure of the natural extracellular matrix (ECM).

The present disclosure further describes the effect of fiber alignment on osteogenic differentiation of bone marrow stromal (BMS) cells. Random and aligned poly(L-lactide) (PLLA) nanofibers were produced by collecting the spun fibers on a stationary plate and a rotating wheel, respectively, as the ground electrode. Morphology and alignment of the BMS cells seeded on the fibers were characterized by SEM. The effect of fiber orientation on osteogenic differentiation of BMS cells was determined by measuring alkaline phosphatase (ALPase) activity, calcium content, and mRNA expression levels of osteogenic markers. There was a strong correlation between the fiber and cell distributions for the random (p=0.16) and aligned (p=0.81) fibers. Percent deviation from ideal randomness (PDIR) values indicated that cells seeded on the random fibers (PDIR=6.5%) were likely to be distributed randomly in all directions while cells seeded on the aligned fibers (PDIR=86%) were highly likely to be aligned with the direction of fibers. BMS cell seeded on random and aligned fibers had similar cell count and ALPase activity with incubation time, but the calcium content on aligned fibers was significantly higher after 21 days compared to that of random fibers (p=0.003). Osteopontin (OP) and osteocalcin (OC) expression levels of BMS cells on fibers increased with incubation time. However, there was no difference between the expression levels of OP and OC on aligned versus random fibers. The results indicate that BMS cells aligned in the direction of PLLA fibers to form long cell extensions, and fiber orientation affected the extent of mineralization, but it had no effect on cell proliferation or mRNA expression of osteogenic markers.

The present disclosure can be better understood with reference to the following examples.

### EXAMPLES

### Example 1

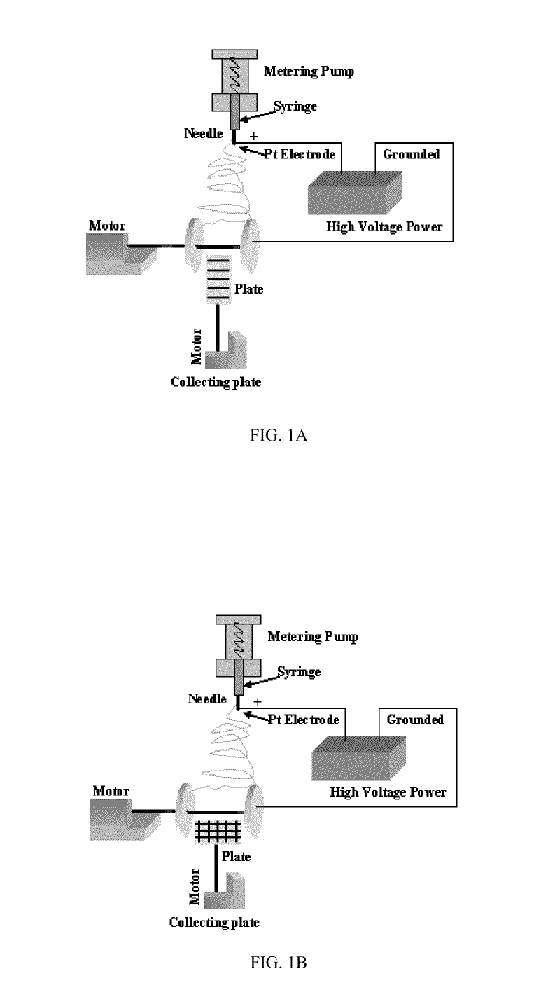

The apparatus for producing electrospun porous scaffolds is shown in FIG. 1a. Electrospinning solution was 5.0 wt % high molecular weight PLGA (Durect; Pelham, Ala.) in 1,1,1,3,3,3-hexafluoro-2-propanol (HFIP). A programmable KDS100 syringe pump (KD Scientific) was used to transfer the polymer solution from a 1 ml syringe to the end of a 21 gauge needle at a specified flow rate of 1.0 ml/h. A positively charged Pt electrode of a high voltage supply (ES40P-5W/DAM, Gamma High Voltage Research) was connected to the end of the needle. Two parallel discs with radius R (custom built) rotate in the same direction with either constant or variable angular speed. These rotating discs play the role of parallel conducting electrodes in parallel conducting collector. The surface of the two disks is covered with a sheet of conducting materials with thickness W. A collector plate connected to a step motor that can move forward and backward and rotate in the plane of the plate (by different degrees) is placed between the two rotating wheels. The force generated by the electric field (20 kV) between the needle and the rotating wheels overcomes the surface tension of the polymer solution and stretches the accelerating jet as fibers along the direction of the main axis of the two wheels on the edge of the two wheels. The aligned fibers are collected on the plate by the rotation of the two wheels to print a fibrous line on the plate with thickness W. Next the collecting plate is moved to forward/backward by the action of a stepping motor and a second line is printed. This process is repeated to print many fiber lines on the collector (lines on the collector in FIG. 1a). Then, the collector plate is rotated by 90 degree as shown in FIG. 1b and the process of line printing is repeated to produce a 2-layer print with cubic pores. The plate is rotated 90 degrees and process is repeated many times to produce a multi-layer nano-fibrous scaffold with cubic pore geometry. Other pore geometries can be produced by using angles other than 90 degrees.

### Example 2

### Materials

PLLA with intrinsic viscosity of 1.1 dL/g and weight average molecular weight of 185 kDa was purchased from Durect Corp. (Pelham, Ala.). Electrospinning solvent 1,1,1,3,3,3-hexafluoro-2-propanol (HFIP) was purchased from VWR (West Chester, Pa.). Ethylenediaminetetraacetic acid disodium salt (EDTA), penicillin, fungizone, gentamicin sulfate (GS), and streptomycin were purchased from Sigma-Aldrich (St. Louis, Mo.). Dulbecco's phosphate-buffered saline (PBS) and Dulbecco's Modified Eagle's Medium (DMEM; 4.5 g/L glucose with L-glutamine and without sodium pyruvate) were obtained from Cellgro (Herndon, Va.). Trypsin and fetal bovine serum (FBS, screened for compatibility with rat bone marrow stromal cells) were obtained from Invitrogen (Carlsbad, Calif.) and Atlas Biologicals (Fort Collins, Colo.), respectively. Quant-it PicoGreen dsDNA reagent kit was obtained from Molecular Probes (Eugene, Oreg.). QuantiChrom calcium assay and QuantiChrom alkaline phosphatase assay kits were purchased from Bioassay Systems (Hayward, Calif.).

### Electrospinning

Schematic diagrams of the electrospinning apparatus for fabrication of random and aligned fibers are shown in FIGS. 1c and 1d, respectively. A programmable KDS100 syringe pump (KD Scientific, Holliston, Mass.) was used to transfer the polymer solution from a 1 ml syringe (Norm-Ject, Henke Sass Wolf GmbH, Germany) to the end of a 21 gauge needle (GTW-PrecisionGlide, 0.7 mm I.D., Becton-Dickinson, Franklin, N.J.) at a specified flow rate of 1.0 mL/h. A positively charged Pt electrode of a high voltage supply (ES40P-5W/DAM, Gamma High Voltage Research) was connected to the end of the needle. For fabrication of random fibers, an aluminum plate connected to the ground electrode was used as the collector A high speed rotational wheel collector (custom built in the Machine Shop at University of South Carolina) was used to prepare aligned fibers. An aluminum wheel (20 cm diameter and 5 mm thickness) connected to a high speed DC motor (model 2M0578, maximum rotation speed of 5000 rpm, Dayton Electric, Niles, Ill.) was placed 15 cm below the needle, with the edge of the wheel facing the needle, as shown in FIG. 1c. The force generated by the high voltage generator (20 kV) between the needle and the collecting plate overcame the surface tension of the polymer solution and stretched the accelerating jet as fibers toward the collector while the solvent evaporated during the process. The polymer jet, after deposition on the collector, was further stretched by the tangential force produced by the rotation of the wheel and formed aligned fibers on the edge of the wheel. The tangential force could be increased by increasing the rotation speed and/or the radius of the wheel. A rotation speed of 1200 rpm and a 20 cm diameter wheel resulted in the production of aligned fibers. For SEM imaging and cell seeding, the aligned fibers were collected on 12 mm diameter glass coverslips attached to the wheel using double sided tape.

### Characterization of Electrospun Fibers

The electrospun fiber mesh was coated with gold (Polaron sputter coater, Quorum Technologies, New Haven, UK) at 20 mA for 1 min. Next, the sample was attached to the SEM stub with conductive double-sided tape and imaged with SEM at an accelerating voltage of 10 kV (JSM-6300V, JEOL, Tokyo, Japan). SEM images were analyzed to determine the average fiber size using the ImageJ software (National Institutes of Health, Bethesda, Md.).

### Isolation of BMS Cells

BMS cells were isolated from the bone marrow of young adult male Wistar rats. After aseptically removing the femurs and tibias, the marrow was flushed out with 20 ml of cell isolation media which consisted of DMEM supplemented with 10% FBS, 100 units/mL penicillin, 100 μg/mL streptomycin, 20 μg/mL fungizone, and 50 μg/mL GS. Plugs were dispersed by shear, cell clumps were broken up by repeatedly pipetting, and the cell suspensions were centrifuged at 200 g for 5 min. The cell pellets were resuspended in 12 mL primary media (DMEM supplemented with 10% FBS, 100 units/mL penicillin, 100 μg/mL streptomycin, 50 μg/mL GS, and 250 ng/mL fungizone) and aliquoted into T-75 flasks. The flasks were subsequently maintained in a humidified 5% CO₂ incubator at 37° C. Cultures were washed with PBS and replaced with fresh media at 3 and 7 days to remove haematopoietic and other unattached cells. After 10 days, cells reached sub-confluent monolayers (yielding approximately 3×10⁶ cells per flask). Cells were rinsed with PBS, enzymatically lifted with 25 μL/cm² 0.05% trypsin/0.53 mM EDTA and centrifuged at 200 g for 5 min. The 2^{nd} passage cells were used for cell culture experiments.

### Cell Seeding

Cell attachment to the nanofiber mesh was done with undifferentiated BMS cells cultured in primary media. The edges of the fiber mesh on the glass coverslip were coated with a silicone sealant (Class VI medical grade liquid silicone rubber; Dow Corning, MI) to prevent separation of the fiber mesh from the coverslip in aqueous solution. The construct was sterilized by ultraviolet radiation for 1 h with a mercury UV lamp (Black-Ray, 365 nm, 100 watts; UVP, Upland, Calif.). The fiber mesh was wetted by immersion in 70% ethanol followed by washing 3 times in PBS. The fiber meshes were conditioned by immersion in primary culture media for 1 h prior to cell seeding. Each sample was seeded with 250 μL of the BMS cell suspension (4×10⁵ cells/mL) in primary media at 1×10⁵ cells/cm² seeding density. After incubation for 24 h for cell attachment, the media was replaced with complete osteogenic media (primary media supplemented with 10 nM dexamethasone, 50 μg/mL ascorbic acid, 10 mM β-glycerophosphate) and cultured in a humidified 5% CO₂ incubator for up to 21 days. Relatively high BMS cell seeding density (1×10⁵ cells/cm²) was used on the fibers because it is reported that cell-cell contact plays a critical role in differentiation of BMS cells. For example, Huss and collaborators reported that canine marrow-derived stromal cells tend to aggregate and form clusters under low cell density to accumulate autocrine factors and preserve viability. They also reported that cells were not able to reach a critical cell density in the absence of cell-cell signaling and ceased to proliferate.

### Morphology of BMS Cells Seeded on Electrospun Fibers

On day 4, samples were washed with PBS and fixed in 4% paraformaldehyde (Sigma-Aldrich) for 40 minutes at ambient conditions. Next, samples were stained with 2% osmium tetroxide (Sigma-Aldrich), dehydrated in sequential ethanol solutions, and dried by critical point drying. The dried specimen were mounted on a stub, coated with gold and imaged with a JEOL SEM at an accelerating voltage of 10 kV.

### Osteogenic Differentiation of BMS Cells Seeded on Electrospun Fibers

For alizarin red staining, cell seeded fibers were fixed with 4% paraformaldehyde for 30 minutes. After washing, cells were stained with 2% Alizarin red S in ddH2O (pH 4.1) for 5 min at ambient conditions. The stained samples were imaged for the presence of mineralized matrix with an inverted microscope (VistaVision, Batavia, Ill.). At each time point (4, 7, 14, and 21 days), cell-seeded fibers were washed with serum-free DMEM for 8 h to remove serum components, washed with PBS, and lysed with 10 mM tris supplemented with 0.2% triton in PBS for measurement of DNA content, ALPase activity and calcium content. The double stranded DNA content of the samples was analyzed using a Quant-it PicoGreen assay according to the manufacturer's instructions. An aliquot (100 μL) of the working solution was added to 100 μL of the cell lysate and incubated for 4 min at ambient conditions. The fluorescence of the solution was measured with a plate reader (Synergy HT, Bio-Tek) at emission and excitation wavelengths of 485 and 528 nm, respectively. The ALPase activity was analyzed using a QuantiChrom ALPase assay according to manufacturer's instructions. The absorbance of p-nitrophenol which is produced by enzymatic cleavage of p-nitrophenyl phosphate by ALPase was measured with a plate reader at 405 nm. A 10 μL aliquot of the sonicated cell lysate was added to 190 μL of the reagent containing 10 mM p-nitrophenyl phosphate and 5 mM magnesium acetate and absorbance was recorded at time zero and again after 4 min. ALPase activity was calculated using the equation [(Aₜ₌₄−Aₜ₌₀)/A_{calibrator}−A_{ddH2O})×808] expressed as IU/L. The total mineralized deposit was determined by measuring the amount of calcium in each sample using a QuantiChrom calcium assay according to manufacturer's instructions. 0.2 mL of 2 M HCl was added to 0.2 mL aliquot of the cell lysate to dissolve the calcium content of the mineralized matrix. Next, a 5 μL aliquot of the suspension was added to 200 μL of the working solution. After 3 min incubation, absorbance was measured on a plate reader at 612 nm. Measured intensities were correlated to the amount of equivalent Ca²⁺ using a calibration curve constructed with reference calcium chloride solutions of known concentration ranging from zero to 200 μg/mL. DNA content, ALPase activity, and calcium content of the samples were measured in triplicate.

mRNA Analysis of BMS Cells Seeded on Electrospun Fibers

Prior to cell culture experiments on random and aligned fibers, BMS cells were seeded in tissue culture plates, cultured in osteogenic media, and the expression of osteogenic markers collagen 1α, OP, OC, ON, and Runx2 was measured at time points 3-18 days. As the incubation time was increased from 3 to 18 days, osteocalcin (OC) had the highest increase in mRNA expression in osteogenic media, followed by osteopontin (OP), and osteonectin (ON). Collagen 1α and Runx2 had the lowest mRNA expression of BMS cells cultured in osteogenic media. For example after 0, 3, 9, 12, and 18 days, OP expression changed from 1 to 13, 20, 23, and 42 while that of Runx2 changed from 1 to -1.5, 0.8, 1.8, and 2, respectively (note that the average error of mRNA measurements was ±2). These results are consistent with those of Byrne and collaborators showing that OP and OC expression of BMS cells seeded in type I collagen-glycosaminoglycan scaffolds increase with incubation in osteogenic media. Although Runx2 expression is restricted to mineralized tissues, in many cases there is not a good correlation between Runx2 level and the expression of genes related to osteogenesis. The most sensitive markers were selected OC, OP, and ON with time points 4, 7, 14, and 21 days.

At each time point, total cellular RNA was isolated using TRIzol (Invitrogen, Carlsbad, Calif.) plus RNeasy Mini-Kit (Qiagen, Valencia, Calif.) according to the manufacturer's instructions. The qualitative and quantitative analysis of the RNA samples was performed with NanoDrop 2000 (Thermo Scientific, Waltham, Mass.). The obtained RNA histograms and gel images were analyzed for the intact 285 and 18S ribosomal RNA. 1 μg of the extracted total RNA was subjected to cDNA conversion using the Reverse Transcription System (Promega, Madison, Wis.). The obtained cDNA was subjected to classical polymerase chain reaction (PCR) amplification with appropriate gene specific primers and the control primer ARBP (acidic ribosomal phosphoproteins) for 35 cycles. Primers for real-time PCR analysis were designed and selected using the Primer3 web-based software as described. The PCR products were analyzed by agarose gel electrophoresis stained with 2% ethidium bromide (Sigma-Aldrich). The annealing temperatures and other parameters for amplification were optimized by classical PCR and agarose gel electrophoresis as described. Real-time PCR (RT-qPCR) was performed to analyze the differential expression of OP, OC, and ON genes with SYBR green RealMasterMix (Eppendorf, Hamburg, Germany) using Bio-Rad iCycler machine (Bio-Rad, Hercules, Calif.) and iCycler optical interface version 2.3 software. The following forward and reverse primers, synthesized by Integrated DNA technologies (Coralville, Iowa) were used: Osteonectin: forward 5′-ACA AGC TCC ACC TGG ACT ACA and reverse 5′-TCT TCT TCA CAC GCA GTT T; Osteopontin: forward 5′-GAC GGC CGA GGT GAT AGC TT and reverse 5′-CAT GGC TGG TCT TCC CGT TGC; Osteocalcin: forward 5′-AAA GCC CAG CGA CTC T and reverse 5′-CTA AAC GGT GGT GCC ATA GAT; collagen 1α: forward 5′-TCC TGC CGA TGT CGC TAT C and reverse 5′-CAA GTT CCG GTG TGA CTC GTG; Runx2: forward 5′-GCT TCT CCA ACC CAC GAA TG and reverse 5′-GAA CTG ATA GGA CGC TGA CGA; and ARBP: forward 5′-CGA CCT GGA AGT CCA ACT AC and reverse 5′-ATC TGC TGC ATC TGC TTG. Quantification of gene expression was based on the crossing-point threshold value (CT; number of cycles required for the RT-qPCR fluorescent signal to cross a threshold) for each sample which was evaluated by the Relative Expression Software Tool (REST™) as the average of three replicate measurements. The expression of the ARBP house-keeping gene was used as the reference and the fold difference in gene expression was normalized to that at time zero. The model of Pfaffl, which includes an RT-qPCR efficiency correction factor of the individual transcripts, was used to determine the expression ratio of the gene. The CT values were processed and analyzed for standard error and significant difference between the groups with the Q-gene software (www.biotechnique.com/softlib/qgene.html).

### Statistical Analysis

Data are expressed as means±standard deviation. Significant differences between two groups were evaluated using a two-tailed student t test. A p value of <0.05 was considered statistically significant.

### Results

### Morphology and Size of the Electrospun Fibers

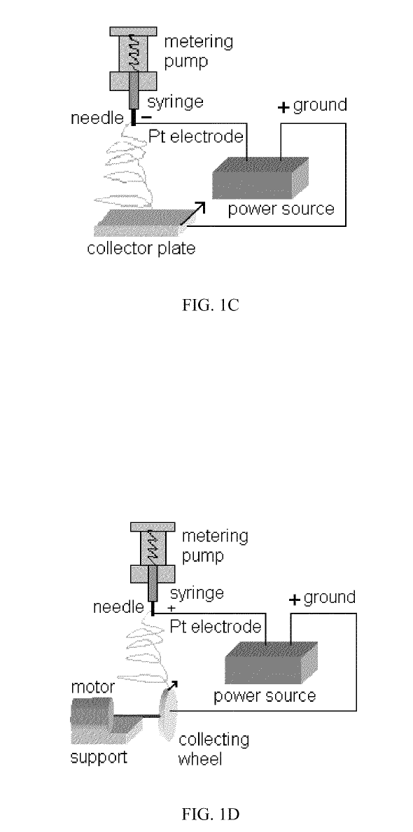

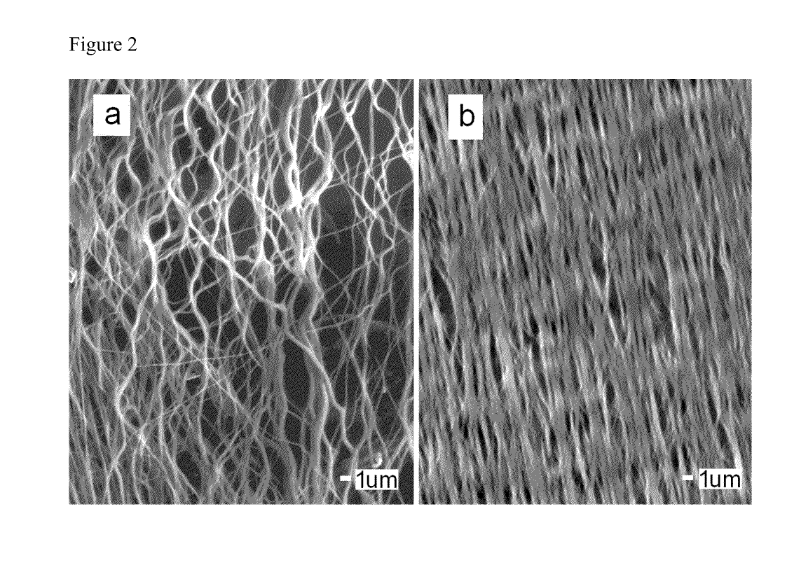

The optimum electrospinning condition for 9 wt % PLLA concentration was 1.0 mL/h injection rate, 25 kV electric potential, and needle-to-collector distance of 7.0 cm. The orientation of the fibers can be controlled by using a rotating wheel as the collector as shown in FIG. 2. Fibers electrospun at 500 rpm had partial alignment with respect to the principle axis of the wheel (FIG. 2a), while those spun at 1200 rpm were completely aligned (FIG. 2b). Therefore, the minimum rotation speed of 1200 rpm and wheel diameter of 20 cm were used to produce aligned fibers. SEM images of the random and aligned electrospun PLLA fibers are shown in FIGS. 3a and 3b, respectively. The diameter of PLLA fibers, determined by image analysis, was in the range of 400-700 nm.

### BMS Cell Morphology on Electrospun Fibers

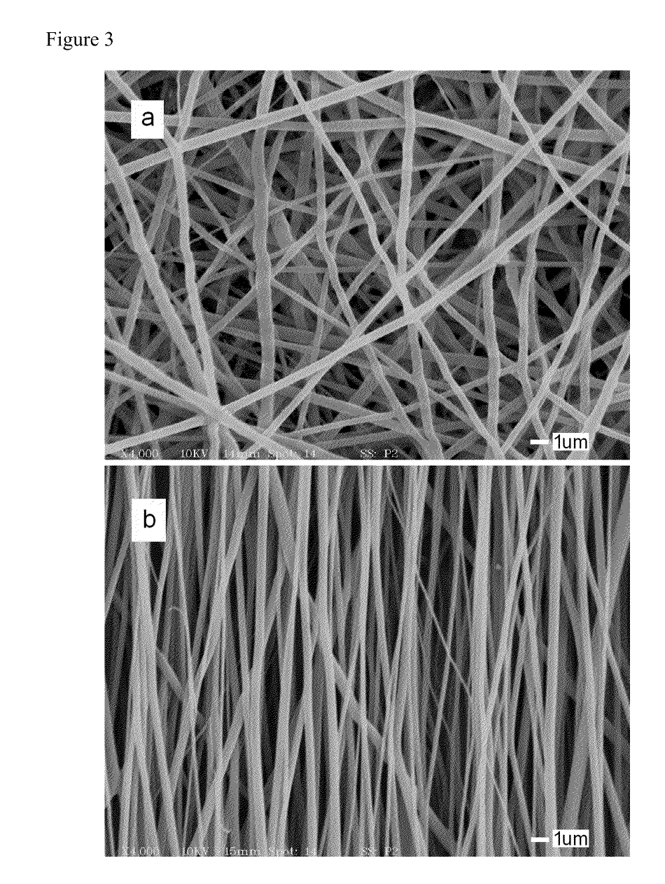

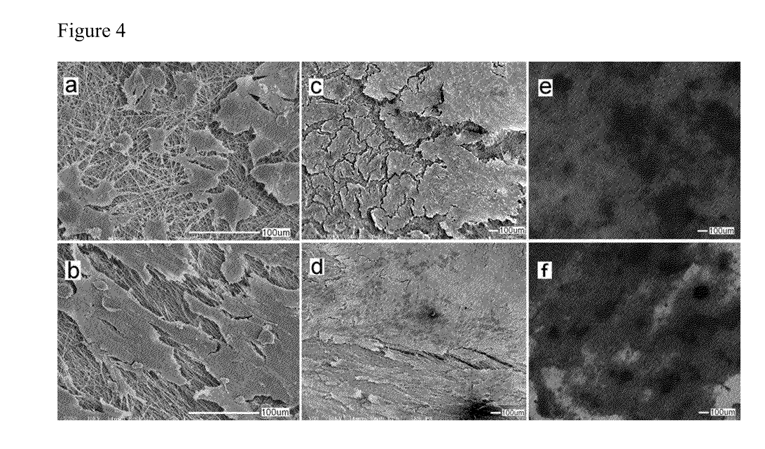

The randomly distributed fibers shown in FIG. 3a and the aligned fibers shown in FIG. 3b were used for cell culture experiments. A typical surface coverage and morphology of the BMS cells on random and aligned PLLA fibers after 4 days of incubation in osteogenic media are shown in FIGS. 4a and 4b, respectively. It should be noted that the observed morphology could be due to shrinkage of the cell aggregates after freeze-drying from confluent cell layers. Nevertheless, the SEM images show the cuboidal to polygonal morphology of the BMS cells on PLLA fibers. The SEM images (a) and (b) in FIG. 5 show extensions of the BMS cells on random and aligned fibers at the higher magnification of 3000×. BMS cells formed short focal-adhesion extensions on random fibers but significantly longer extensions on aligned fibers.

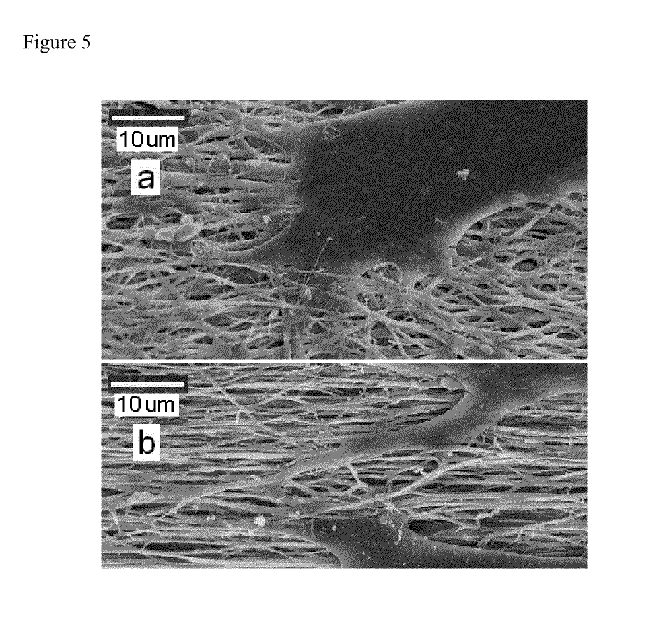

The distribution of random and aligned fibers and the seeded cells as a function of angle of orientation are shown in FIGS. 6a and 6b, respectively. The fibers collected on the plate had a wide distribution of ±90° with respect to the reference direction while those collected on the rotating wheel had a narrow distribution of ±20°. Fibers collected on the plate were randomly distributed while those collected on the spinning wheel were preferentially aligned along the direction tangent to the wheel perimeter. The deviation from ideal randomness was calculated from the sample variance using the following equation:

$$P D I R = ( 1 - \sqrt{\frac{{V}_{sample}}{{V}_{ideal}}} ) \times 100$$

Where PDIR is percent deviation from ideal randomness, Vₛₐₘₚₗₑ is the variance of the fibers/cells with respect to the reference direction and V_{ideal} is the variance of the fibers/cells with ideally random distribution. PDIR ranges from 0-100% with zero and 1 corresponding to ideally random and completely aligned, respectively. The PDIR for fibers collected on the plate and rotating wheel was 6.5% and 86%, respectively. The PDIR for cells seeded on the random and aligned fibers was 23% and 82%, respectively. There was a strong correlation between the fiber and cell distributions for the random (p=0.16; p<0.05 indicates no correlation) and aligned (p=0.81). PDIR and p-values indicate that cells seeded on the random fibers (PDIR=6.5%) were likely to be distributed randomly in all directions (PDIR=23%) while cells seeded on the aligned fibers (PDIR=86%) were highly likely to be aligned with the direction of fibers (PDIR=82%).

### Osteogenic Differentiation of BMS Cells on Electrospun Fibers

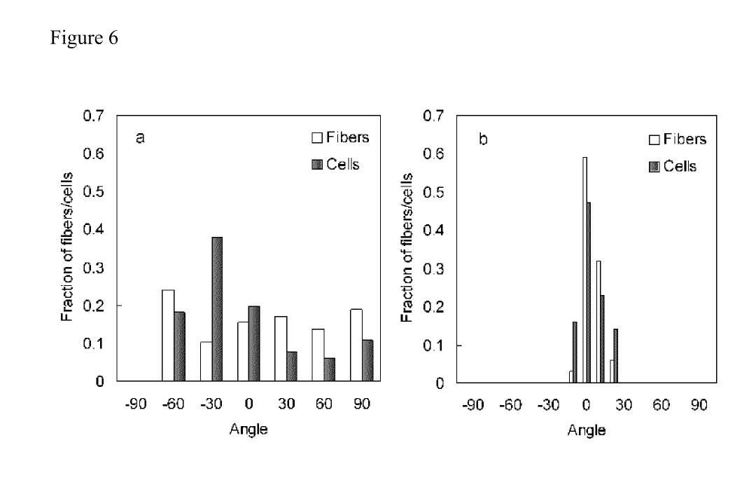

BMS cells were seeded on random and aligned PLLA fibers and cultured in osteogenic media. Morphology of the seeded cells on random and aligned PLLA fibers after 4 days of incubation in osteogenic media are shown in FIGS. 4a and 4b, respectively. FIGS. 4c and 4d show sheets of mineralized matrix produced by the cells seeded on random and aligned fibers, respectively. The produced ECMs on random and aligned fibers stained positive for alizarin red (intense red color), as shown in FIGS. 4e and 4f, respectively. At each time point, DNA content, ALPase activity and calcium content of the BMS cells were analyzed. FIG. 7a shows the DNA content of the BMS cells on random and aligned fibers with incubation time. There was no statistically significant difference between the DNA content of random and aligned fibers with incubation time. The DNA content on random fibers changed from 555±65 to 520±130, 395±14 and 620±11 ng/mL after 4, 7, 14, and 21 days, respectively, while that of aligned fibers changed from 550±45 to 460±12, 430±21, and 500±10. For both random and aligned fibers, the DNA content after 14 days was significantly lower than all other days as indicated by a star in FIG. 7a. It has been demonstrated that differentiation in osteogenic media reduces the proliferative capacity of BMS cells. For example, it has been observed that the cell content of silk scaffolds, seeded initially with equal cell numbers, decreased to 0.0015±0.0003% of the scaffold weight after 36 days of incubation in osteogenic media, compared to 0.0088±0.002% in basal media. The cell numbers in FIG. 7a are consistent with results in which the proliferation rate of human coronary artery smooth muscle cells seeded on aligned poly(L-lactide-co-∈-caprolactone) nanofibers was similar to that on tissue culture polystyrene plates.

FIG. 7b shows ALPase activity of the BMS cells on random and aligned fibers with incubation time. There was no statistically significant difference between the ALPase activity of random and aligned fibers with incubation time. The ALPase activity of the BMS cells on random fibers changed from 0.38±0.04 to 0.79±0.07, 1.76±0.15 and 1.31±0.30 IU/μg after 4, 7, 14, and 21 days, respectively, while that of aligned fibers changed from 0.41±0.04 to 0.99±0.13, 1.95±0.13, and 1.32±0.06. The ALPase activity peaked after 14 days for both random and aligned fibers. Differentiation of BMS cells to osteoblasts takes place in two phases of maturation and mineralization. In the maturation phase, ALPase increases and peaks which lasts between 8-12 days. Once the mineralization phase begins, ALPase starts to decrease while calcium content starts to increase. FIG. 7c shows the calcium content of the BMS cells on random and aligned fibers with incubation time. The calcium content on random fibers changed from 30±3 to 41±1, 114±16 and 234±14 mg/mg DNA after 4, 7, 14, and 21 days, respectively, while that of aligned fibers changed from 37±3 to 50±3, 95±20, and 420±6. The calcium content was significantly higher on days 14 and 21 compared to days 4 and 7 for random and aligned fibers. Furthermore, calcium content of the BMS cells, normalized to cell number, on aligned fibers after 21 days was significantly higher than that of random fibers (234±14 mg/mg DNA for random versus 420±6 for aligned; p=0.003). It has been reported that PLGA nanofibers support differentiation of human BMS cells to osteogenic and vasculogenic lineages, but they did not compare the extent of mineralization on random and aligned fibers.

The SEM images (a) and (b) in FIG. 5 show the extensions of BMS cells on random and aligned fibers at the higher magnification of 3000×. BMS cells formed short focal-adhesion extensions on random fibers but significantly longer extensions on aligned fibers. The long extensions are likely due to the higher modulus of the fibers in the direction of alignment. The longer cell extensions on aligned fibers can increase the effective contact area of the cell with the substrate, leading to the measured increase in mineralization. The observed increase in mineralization for aligned fibers may also be due to preferred mineral nucleation on the longer cell extensions.

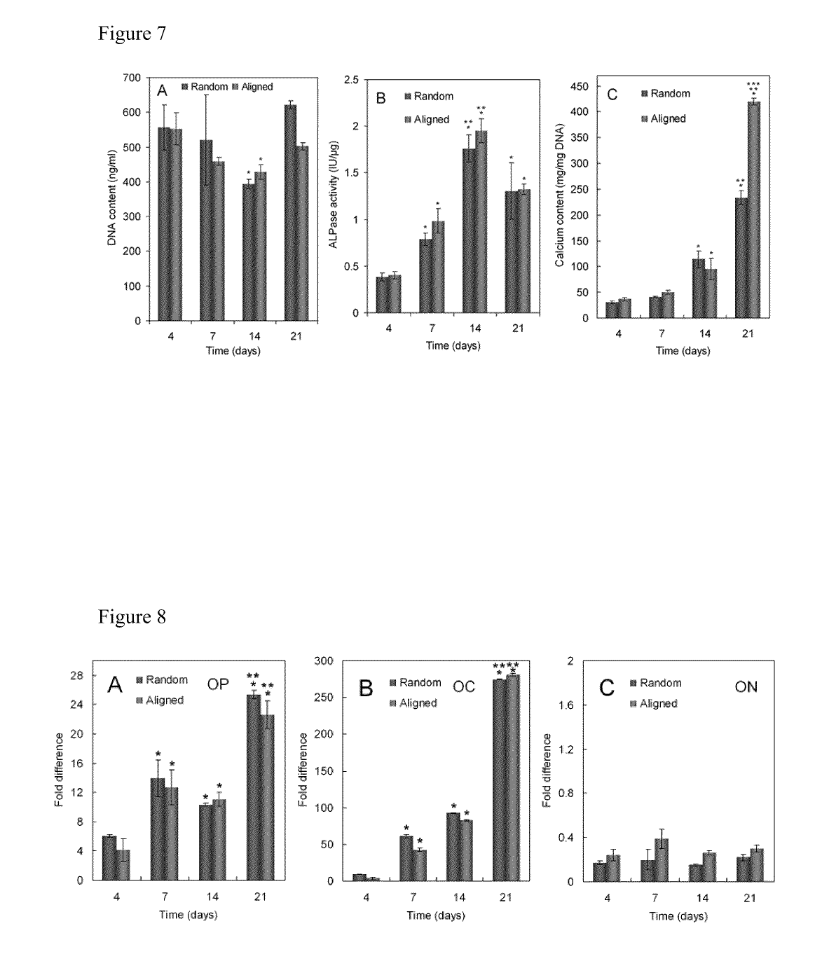

The expression level of osteogenic markers OP, OC, and ON as a function of time for random and aligned fibers is shown in FIGS. 8a, 8b, and 8c, respectively. In FIGS. 8a-c, one star indicates statistical difference between the test time point and day 4 and two stars indicate difference between the test time and all other time points in the same group. Overall, OP and OC expression levels increased while that of ON did not change with incubation time for random and aligned fibers. The OP expression (FIG. 8a) increased from 6.1±0.2 to 13.9±2.5, 10.3±0.2 and 25.4±0.6 fold on random fibers after 4, 7, 14, and 21 days, respectively, while that on aligned fibers increased from 4.1±1.5 to 12.7±2.4, 11.1±0.9 and 22.6±1.9 fold. There was a significant increase in OP expression on random and aligned fibers on days 7 and 14 compared to day 4, and a significant increase on day 21 compared to all other days. The OC expression (FIG. 8b) increased from 9.4±0.4 to 61±3, 92±4 and 274±5 fold on random fibers after 4, 7, 14, and 21 days, respectively, while that on aligned fibers increased from 3.4±0.7 to 42±6, 83±6 and 281±13 fold. There was a significant increase in OC expression on random and aligned fibers on days 7 and 14 compared to day 4, and a significant increase on day 21 compared to all other days. The ON expression (FIG. 8c) did not change significantly with incubation time on random and aligned fibers.

The variation in gene expression levels of osteogenic markers in FIG. 8 with incubation time is consistent with previously reported expression levels for BMS cells. For example, BMS cells seeded on porous type I collagen-glycosaminoglycan scaffolds had significantly higher expression of OP and OC after 14 and 21 days of culture in osteogenic media.

### Discussion

Many parameters such as electrospinning solvent, polymer concentration and molecular weight, flow rate, electric field strength, needle-to-collector distance, and collector geometry can be manipulated to control size, morphology, and orientation of electrospun fibers. For example, it has been shown that the minimum polymer concentration to produce fibers, and eliminate bead formation, in dichloromethane was 12 wt %. Below that critical concentration, surface tension breaks the accelerating jet from the tip of the capillary into droplets. Above the critical concentration, surface tension of the jet is overcome by the repulsive force from the induced charge distribution on the droplet, resulting in the collection of fibers on the target. The higher electrical conductivity of HFIP solvent, compared to dichloromethane, affected the whipping instability of the spinning jet and generated a higher stretching force in the electric field, which resulted in the production of bead-free electrospun fibers at the minimum PLLA concentration of 9 wt %.

The distribution and organization of human coronary artery smooth muscle cells (SMCs) on aligned poly(L-lactide-co-∈-caprolactone) PLLA-CL fibers has been investigated. It was observed that SMCs migrated along the axis of the aligned fibers and α-actin filaments of the cell cytoskeleton were parallel to the direction of fibers. But the effect of fiber orientation on differentiation of SMCs was not reported. Previous studies have reviewed morphology and outgrowth of neurite stem cells (NSCs) on PLLA fibers. According to the results, neonatal mouse cerebellum stem cells (NSCs) elongated to a greater extent on aligned PLLA fibers, compared to random fibers, but cell differentiation was independent of fiber orientation. Morphology, orientation, and proliferation of NIH 3T3 fibroblasts on PLGA fibers has also been investigated. An increase in the projected cell area and aspect ratio with increase in fiber alignment was observed but cell proliferation was insensitive to fiber orientation. Consistent with those previous studies, the cell morphologies in FIGS. 4-5 indicate that BMS cells tend to elongate along the fiber direction when seeded on aligned fibers. The present results show that BMS cells align in the direction of PLLA fibers and fiber orientation affects the extent of mineralization but has no effect on cell proliferation or mRNA expression of osteogenic markers.

Osteogenic differentiation of BMS cells can be affected by the separation distance between the fibers or fiber proximity. For example in the bone matrix, parallel collagen molecules touching each other and apatite crystals arrange into a staggered pattern to form fibrils, the building block of the mineralized tissue. Therefore, aligned fibers touching each other resemble the arrangement of collagen fibers in the mineralized tissue. Furthermore, with increasing fiber proximity, the effective surface area for cell attachment to the substrate is reduced because fewer cell extensions can penetrate the interstitial space between the fibers. In the limit as the fibers touch each other, the aligned fiber mesh becomes a 2D substrate with line patterns.

Osteogenic differentiation of BMS cells depends on soluble factors, specific interactions between the cell and substrate, and the structure of the substrate. For example, the addition of soluble factor recombinant human bone morphogenetic protein-2 (rhBMP-2) to osteogenic media significantly enhances gene expression and osteogenic differentiation of BMS cells. It has also been shown that covalent attachment of RGD peptides to a substrate facilitates spreading and focal point adhesion of BMS cells and increases the expression of markers for osteogenic differentiation. The focus of the present example was on the effect of substrate structure (random versus aligned fibers) on differentiation and gene expression of BMS cells in osteogenic media. The results of this example demonstrate that fiber alignment alone, in the absence of biochemical factors, does not affect gene expression. However fiber alignment affects cell morphology on the substrate and increases calcium deposition. This does not mean that fiber alignment in general has no effect on gene expression. It is possible for fiber alignment to modulate osteogenic expression of BMS cells in combination with other factors, such as covalent attachment of cell adhesion peptides to the substrate.

In the interests of brevity and conciseness, any ranges of values set forth in this specification are to be construed as written description support for claims reciting any sub-ranges having endpoints which are whole number values within the specified range in question. By way of a hypothetical illustrative example, a disclosure in this specification of a range of 1-5 shall be considered to support claims to any of the following sub-ranges: 1-4; 1-3; 1-2; 2-5; 2-4; 2-3; 3-5; 3-4; and 4-5.

These and other modifications and variations to the present disclosure can be practiced by those of ordinary skill in the art, without departing from the spirit and scope of the present disclosure, which is more particularly set forth in the appended claims. In addition, it should be understood that aspects of the various embodiments can be interchanged both in whole or in part. Furthermore, those of ordinary skill in the art will appreciate that the foregoing description is by way of example only, and is not intended to limit the disclosure.

What is claimed is:

1. A method for fabricating multi-layer scaffolds with a well-defined pore geometry comprising:
electrospinning biodegradable synthetic polymer fibers onto a collector plate, wherein the fibers on the collector plate are generally aligned as they are electrospun onto the collector plate;
rotating the collector plate and electrospinning additional biodegradable synthetic polymer fibers onto the collector plate, wherein the additional fibers on the collector plate are generally aligned as they are electrospun onto the collector plate and a multi-layer scaffold is formed.

2. The method of claim 1, wherein the collector plate comprises a motor.

3. The method of claim 1, wherein the collector plate is rotated 90 degrees.

4. The method of claim 1, wherein the collector plate is rotated less than 90 degrees.

5. The method of claim 1, wherein the collector plate is rotated greater than 90 degrees.

6. The method of claim 1, wherein the collector plate can move forward and backward.

7. The method of claim 1, further comprising an electrode and two rotating parallel disks comprising conducting material, wherein the fibers and the additional fibers pass through the electrode and the two parallel disks as they are electrospun, the two parallel disks acting as parallel conducting electrodes.

8. The method of claim 7, wherein the conducting material has a thickness W and the aligned fibers form a line having a thickness W.

9. The method of claim 1, wherein the scaffold comprises a cubic pore geometry.

10. The method of claim 1, wherein the synthetic polymer comprises collagen, gelatin, chitosan, poly(L-lactide), poly(lactic acid), poly(glycolic acid), and poly(lactide-co-glycolide), or combinations thereof.

11. The method of claim 1, wherein the synthetic polymer comprises poly(L-lactide).

12. The method of claim 1, wherein the synthetic polymer comprises poly(lactic acid).

13. The method of claim 1, wherein the synthetic polymer comprises poly(glycolic acid).

14. A method for fabricating a multi-layer scaffold with a well-defined pore geometry comprising:
electrospinning biodegradable synthetic polymer fibers onto a collector plate, wherein the fibers on the collector plate are generally aligned as they are electrospun onto the collector plate;
moving the collector plate forward or backward and electrospinning additional biodegradable synthetic polymer fibers onto the collector plate, wherein the additional fibers are generally parallel with the fibers on the collector plate and are generally aligned as they are electrospun onto the collector plate, the generally parallel rows being separated by a distance.
rotating the collector plate and electrospinning still additional biodegradable synthetic polymer fibers onto the collector plate, wherein the still additional fibers on the collector plate are generally aligned as they are electrospun onto the collector plate and a multi-layer scaffold is formed.

15. The method of claim 14, wherein the collector plate comprises a motor.

16. The method of claim 14, wherein the collector plate is rotated 90 degrees.

17. The method of claim 14, wherein the collector plate is rotated less than 90 degrees.

18. The method of claim 14, wherein the collector plate is rotated greater than 90 degrees.

19. The method of claim 14, wherein the collector plate moves forward and backward.

20. The method of claim 14, wherein the distance between the generally parallel rows on the collector plate can vary the porosity of the scaffold.
